(19) United States
(12) Patent Application Publication
(10) Pub. No.: US 2008/0206451 A1
(43) Pub. Date: Aug. 28, 2008

(54) Foaming Chemical Grout

(76) Inventors: Sang-woon Kwak, Seoul (KR); Ji-young Kwak, Kyunggi-Do (KR)

Correspondence Address: CANTOR COLBURN, LLP, 20 Church Street, 22nd Floor, Hartford, CT, 06103, US

(21) Appl. No.: 11/579,042

(22) PCT Filed: Apr. 29, 2005
(86) PCT No.: PCT/KR05/01256

§ 371 Date: Nov. 30, 2007

(30) Foreign Application Priority Data
Apr. 30, 2004 (KR) 10-2004-0030400

(51) Int. Cl. C08K 3/22; B32B 43/00

(52) U.S. Cl. 427/140; 524/436; 524/401

(57) ABSTRACT

The present invention relates to a foaming chemical grout, particularly a foaming chemical grout comprising an epoxy resin (based on solids), a glass powder, a filling agent, an alkali metal compound or alkali earth metal compound, a metal powder, a hardening agent and a solvent. And it also relates to a method for the construction, repair or reinforcement of a structure which is characterized in that the foaming chemical grout is used.

The foaming chemical grout in accordance with the present invention has excellent filling performance in upper sides against gravity, especially crack and eroded cave regions having counter direction against gravity like ceilings due to its excellent foaming ability when injected and foamed, has high-intensity, closed pore structures thereby resulting in excellent filling effects even in places subject to pressure or load, has excellent adhesion and working performances thereby enabling single process without requiring additional processes even in wet and aquatic environments, and is easy and simple to operate thereby having excellent effects on the construction, repair and reinforcement of a structure.

### TECHNICAL FIELD

The present invention relates to a foaming chemical grout and more particularly, it relates to a foaming chemical grout having excellent filling performance in upper sides against gravity, especially crack and eroded cave regions having counter direction against gravity like ceilings due to its excellent foaming ability when injected and foamed, having high-intensity, closed pore structures thereby resulting in excellent filling effects even in places subject to pressure or load, having excellent adhesion and working performances thereby enabling single process without requiring additional processes even in wet and aquatic environments, and being easy and simple to operate thereby having excellent effects on the construction, repair and reinforcement of a structure, and a method for the construction, repair and reinforcement of a structure using it.

BACKGROUND ART

Grouts refer to injection materials which are injected as a filling material into structures, fractured gaps of grounds, cavities, etc. for leakage stopping work or soil stability in civil engineering.

The injection materials are filled using gravity or pump and employed to repair the crack portions of constructs or to reinforce the bearing power of foundation stone parts and machine pedestals.

The grouts are classified into grouts for the ground under the water, ground-improvement grouts, filling grouts, reinforcement grouts and the like according to their construction purpose, classified into cavity grouts, aperture grouts and the like according to their injection place, and classified into cement grouts, iron-type grouts, asphalt grouts, chemical grouts and the like according to their main ingredient.

When the cracks of structures are left uncared, the exterior view of the structures is impaired and also, the cracks become more deteriorated thereby reducing the life time of the structures due to water leakage, contamination, corrosion of arranged steel rods and may cause huge disasters such as collapse of Seongsudaegyo Bridge. Accordingly, appropriate repair and reinforcement are required.

The cracks are generated by inappropriate use of materials, poor construction, usage, external environment, etc. and they have several shapes according to their origination.

Of the previously-known grouts, asphalt grouts are used mainly for waterproof and soil stability, and iron-type grouts are widely used for filling of steel frames or filling reinforcement of joint parts due to their chemical non-shrink action and high intensity.

Cement grouts using cements, water, clays, etc. were mainly employed in the beginning but since 1919, chemical grouts have been primarily used.

In recent, technology relating to chemical grouts has been rapidly improved due to the finding of vinyl polymers or chrome lignin, and such chemical grouts have been used mostly for the improvement of waterproof or grounds and the repair and the supplement of structures.

In prior arts, chemical grouts comprising epoxy resins as a main ingredient and sodium silicates as a filling agent were most widely used as a chemical grout.

However, the chemical grouts of which the main ingredient is epoxy resins have the drawbacks that due to high oil-absorption rate of sodium silicate to the resins, it is absorbed instead of being filled into crack or eroded cave regions and thus it does not exhibit its original function as a filling agent and also the intensity of the grouts is decreased and adhesion between cracks is decreased thereby causing re-formation of cracks.

Besides, when the grouts containing conventional epoxy resins and sodium silicates as main ingredients are injected into cracks, the injection of the grouts is not easy due to water or bubbles which are present in the cracks, and particularly in cracks or pipes of which width is narrow, the presence of water or bubbles makes the injection of the grouts more difficult. Also, as the grouts are absorbed into a main body or hardened or shrank, substantially complete filling into the cracks is difficult.

Further, the grouts having epoxy resins as a main ingredient show big difference from concrete structures in aspects of viscosity and intensity, and due to their higher elasticity compared with concretes, material separation phenomena at the interfaces is more likely to happen when stress is generated outside.

Furthermore, prior repair and reinforcement methods of structures are complicated, it takes long time to restore the original state, the restoration of impaired external appearance is not perfect, and re-crack frequently occurs.

In addition, when grouts need to be filled into crack regions having counter direction against gravity such as the ceilings of constructs, the prior grouts run down from the filling site so that it is difficult to work with them and also, the properties are not supported.

Accordingly, there is a demand on grouts which enable the construction of crack or eroded cave regions of constructs in easy and simple way and do not generate re-crack.

### DISCLOSURE OF INVENTION

### Technical Problem

In order to solve the above-mentioned problems, it is an object of the present invention to provide a foaming chemical grout having excellent filling performance in upper sides against gravity, especially crack and eroded cave regions having counter direction against gravity like ceilings due to its excellent foaming ability when injected and foamed, having high-intensity, closed pore structures thereby resulting in excellent filling effects even in places subject to pressure or load, having excellent adhesion and working performances thereby enabling single process without requiring additional processes even in wet and aquatic environments, and being easy and simple to operate thereby having excellent effects on the construction, repair and reinforcement of a structure.

It is another object of the invention to provide a foaming chemical grout which is completely filled into cracks thereby enabling superior adhesion between the cracks and at the same time, which possesses satisfactory acid resistance, alkali resistance, injection performance, inflow performance, impact resistance, crack resistance, adhesion, and storage ability.

Also, it is another object of the invention to provide an excellent repair and reinforcement method of a structure, wherein the method has affinity with materials; due to simple construction and fast hardening, it enables the function and shape of the structure to be completely restored within short time; it supplements the properties of the structure such as tensile strength and strongly adheres to the structure thereby extending the life-time of the structure; and it enables the perfect restoration of damaged external appearance.

### Technical Solution

To achieve the aforementioned objects, the present invention provides a foaming chemical grout comprising:

a) 100 parts by weight of an epoxy resin (based on solids);

b) 10 to 500 parts by weight of a glass powder;

c) 10 to 500 parts by weight of a filling agent;

d) 1 to 500 parts by weight of an alkali metal compound or alkali earth metal compound;

e) 1 to 500 parts by weight of a metal powder;

f) 10 to 100 parts by weight of a hardening agent; and

g) 10 to 500 parts by weight of a solvent.

Further, the invention provides a method for the repair or reinforcement of a structure which is characterized in that the foaming chemical grout is applied to a crack region, eroded cave region or shocrete construction.

### Advantageous Effects

The foaming chemical grout in accordance with the present invention has excellent filling performance in upper sides against gravity, especially crack and eroded cave regions having counter direction against gravity like ceilings due to its excellent foaming ability when injected and foamed, has high-intensity, closed pore structures thereby resulting in excellent filling effects even in places subject to pressure or load, has excellent adhesion and working performances thereby enabling single process without requiring additional processes even in wet and aquatic environments, and is easy and simple to operate thereby having excellent effects on the construction, repair and reinforcement of a structure. Also, the foaming chemical grout of the invention satisfies acid resistance, alkali resistance, injection performance, inflow performance, impact resistance, crack resistance, adhesion, and storage ability at the same time, and further it has affinity with materials, it enables the function and shape of the structure to be completely restored within short time due to simple construction and fast hardening, it supplements the properties of the structure such as tensile strength and strongly adheres to the structure thereby extending the life-time of the structure, and it enables the perfect restoration of damaged external appearance.

### BRIEF DESCRIPTION OF THE DRAWINGS

FIG. 1 is a front view showing the hardening result of the foaming chemical grout prepared in accordance with one embodiment of the present invention and a prior chemical grout.

FIG. 2 and FIG. 3 are side views showing the hardening results of the foaming chemical grout prepared in accordance with one embodiment of the present invention and a prior chemical grout.

FIG. 4 is a sectional view of the chemical grout prepared in the invention which is injected into a cylinder-shaped barrel of which the inside is empty and foamed and then hardened.

### MODE FOR THE INVENTION

The invention is further described in detail.

The foaming chemical grout of the present invention is characterized in that it comprises an epoxy resin, glass powder, filling agent, alkali metal compound or alkali earth metal compound, metal powder, hardening agent and solvent.

Preferably, the invention comprises a main ingredient containing

i) 100 parts by weight of an epoxy resin (based on solids);

ii) 10 to 500 parts by weight of a glass powder;

iii) 10 to 490 parts by weight of a filling agent;

iv) 1 to 500 parts by weight of an alkali metal compound or alkali earth metal compound; and

v) 10 to 500 parts by weight of a solvent; and a hardener containing

i) 1 to 500 parts by weight of a metal powder;

ii) 10 to 490 parts by weight of a filling agent; and

iii) 10 to 100 parts by weight of a hardening agent.

The epoxy resin of a) in the invention is not limited to specific ones and any ordinary epoxy resins can be used.

The epoxy resin is preferably solventless epoxy resins having molecular weights within the range of 350 to 3,000 MW of diglycidyl types and triglycidyl types.

Particularly, for the epoxy resin, there can be used any known epoxy resins such as bisphenol A epoxy resin, bisphenol F epoxy resin, bisphenol S epoxy resin, alicyclic epoxy resin, aliphatic cyclic epoxy resin, phenol novolak epoxy resin, cresol novolak epoxy resin, bisphenol A novolak epoxy resin, diglycidyl ether of biphenol, diglycidyl ether of naphthalenediol, diglycidyl ether of phenol, diglycidyl ether of alcohol, or alkyl substituents, halides or hydrogen additives thereof.

The epoxy resin serves as a binder conferring adhesion to cements, concretes and the like which are adhered to the cracks or apertures into which the chemical grouts are injected, and provides acid resistance and alkali resistance to the chemical grout.

When the amount of the epoxy resin is too low, adhesion to cements, concretes, etc. is decreased, and when its amount is too high, hardness, intensity and other properties as a grout material are deteriorated.

The glass powder of b) in the invention is used to increase the intensity and viscosity of the chemical grout thereby maximizing impact resistance and tensile strength and it inhibits the expansion of volume according to temperature increase and hardening shrinkage.

Glass powders having various particle shapes and sizes can be employed as the glass powder. The particles of the glass powder are obtained by milling glass, cullet, glass fiber, or glass cullet wherein the glass components are not limited to specific ones as long as they are compatible to the resins and they include A, C, E, alkali resistance glass powder components, etc. Particularly, the glass powder of E-glass components is advisable in aspect of adhesion to various resins.

The diameter of the glass powder is not specially limited, but it is preferably 10 [symbol] to 1 [symbol] , more preferably 50 [symbol] to 1 [symbol] . Also, as the glass powders have the function to fill apertures, it is advisable to use ones having small diameters if possible. When the diameter of the glass powder is too small, the viscosity of the grout may largely increase, and when it is too big, the function to fill apertures is decreased so that the intensity of the grout may be decreased or shrinkage and expansion may increase.

As the glass powder does not absorb resins or water, it can be used in a large amount within the grout and particularly, it disperses well in the resin and has excellent volume filling effects even though the content of the glass powder is high.

In particular, it is preferred that the glass powder is contained in an amount of 10 to 500 parts by weight of 100 parts by weight of the solid epoxy resin. When the amount is less than 10 parts by weight, shrinkage and expansion may increase, and when it exceeds 500 parts by weight, its viscosity is too high and thus the injection into cracks is difficult and the content of the epoxy resin is relatively low so that the adhesion of chemical grout may be decreased. Also, when the chemical grout of the invention is used while being divided into the main ingredient and the hardener, the glass powder can be divided into appropriate amounts and contained in the main ingredient and the hardener and preferably, it is contained in an amount of 10 to 490 parts by weight in the main ingredient and the hardener, respectively.

It is advisable to determine the amount of the glass powder considering not only the size of cracks but also the depth of the cracks and the amount of foreign substances such as bubbles between the cracks. For example, in case of the injection into deep cracks, it is advisable to reduce the amount of the glass powder and instead, to add a filling agent (especially, glass beads) thereby injecting the grout having excellent fluidity and injection performances.

Further, when the glass powder is added to the chemical grout, if the injection of the grout is carried out at a low temperature, it is preferable to lower its viscosity by decreasing the content of the glass powder and on the other hand, if the injection of the grout is carried out at a high temperature, it is advisable to raise its viscosity by increasing the content of the glass powder.

As the glass powder, which is an ingredient equal or similar to concrete as compared with synthetic resins, has similar physical properties such as intensity or hardness, it inhibits interfacial separation and it absorbs and transmits impacts from outside so that it forms grout structure of which the damage is remarkably decreased.

The type and amount of the filling agent of c) in the invention can be adjusted according to the characteristics of crack or eroded cave region or the type and amount of the resin used. In particular, there can be used light carbonates such as glass bead, calcium carbonate (CaCO₃), calcium sulfate and barium sulfate, clays such as white clay, dix clay and yellow clay, diatomaceous earth such as ash, and silica (SiO₂).

Preferably, the glass bead is used.

For the glass beads, sphere, oval, or any other corresponding shapes can be used and also, there can be used all kinds of from those where various sizes are distributed to those having only a selected certain size.

The diameter of the glass beads can be suitably selected according to the purpose of construction and the depth of the construction and preferably, those having 1 [symbol] to 3 [symbol] can be used. In addition, it is possible to have various morphology and properties by the combination of beads having small diameters of several and beads having large diameters of several [symbol] . However, if the diameter exceeds 3 [symbol] , dispersion ability becomes low and they cannot be effectively used in places where the size of cracks is less than 3 [symbol] . In particular, it is preferable to use the glass beads of large diameters in a relatively large amount in places where the gap of cracks is wide and to use the beads of small diameters in a small amount in places where the gap of cracks is narrow.

The glass bead provides very superior fluidity by ball bearing effect when added as a filing agent to the epoxy resins, thereby resulting in excellent injection performances into cracks, and it also provides excellent dispersion ability with regard to other additives and gives no defects after injection. In addition, even after the mixture of the resin and the filling agent is stored for a long time, they are mixed well by simple stirring thereby exhibiting excellent storage ability. Also, as the glass bead has higher intensity and hardness than general silica or silica fame and it has a shape close to a spherical one, it absorbs and disperses well impacts from outside. Accordingly, the foaming chemical grout of the invention to which the glass bead is added as a filling agent possesses excellent impact resistance.

The filling agent is contained preferably in an amount of 10 to 500 parts by weight of the 100 parts by weight of the solid epoxy resin, more particularly in an amount of 10 to 300 parts by weight. When the amount is less than 10 parts by weight, the fluidity of the chemical grout becomes low and after hardening, intensity and hardness may become low, and when it exceeds 500 parts by weight, as the content of the epoxy resin is relatively reduced, the intensity of the chemical grout may be low and after the hardening, the chemical grout might fall off. Also, when the chemical grout of the invention is used while being divided into the main ingredient and the hardener, the filling agent can be divided into appropriate amounts and contained in the main ingredient and the hardener and preferably, it is contained in an amount of 10 to 490 parts by weight in the main ingredient and the hardener, respectively.

The alkali metal compound or alkali earth metal compound of d) of the invention has a role in controlling the foaming extent of the foaming chemical grout.

For the alkali metal compound or alkali earth metal compound, there can be used alkali metal compounds containing Li, Na, K, Rb, Cs or Fr, or alkali earth metal compounds containing Be, Mg, Ca, Sr, Ba, or Ra and in particular, it is preferable to use Na-containing Na alkali metals, for example, NaCl or NaCO .

The content of the alkali metal compound or alkali earth metal compound can be adjusted by the extent of the required foaming and in particular, it is contained preferably in an amount of 1 to 500 parts by weight of 100 parts by weight of the solid epoxy resin, more particularly, in an amount of 10 to 300 parts by weight. When the amount is less than 1 part by weight, it results in too little foaming, and when it exceeds 500 parts by weight, it results in too much foaming.

The metal powder of e) in the invention has the function to form bubbles by metal reaction.

For the metal powder, there can be used metal powders containing Al, Zn, Fe, Ni, Sn, Pb, or Cu and in particular, it is preferable to use an alloy or metal powder containing aluminum in aspect of foaming ability and more preferably to use aluminum powder.

The metal powder is contained preferably in an amount of 1 to 500 parts by weight of 100 parts by weight of the solid epoxy resin, more particularly in an amount of 1 to 100 parts by weight. The above-mentioned range is advantageous in aspect of the formation of bubbles.

The hardening agent of f) in the invention has a role in hardening the chemical grout at a room temperature.

Ordinary hardening agents can be employed as the hardening agent and in particular, it is preferable to use ordinary epoxy hardening agents.

The hardening agent is contained preferably in an amount of 10 to 100 parts by weight of 100 parts by weight of the solid epoxy resin, and this range is advantageous for the hardening of the grout.

Besides the above-mentioned components, the chemical grout of the invention comprises a solvent, which is contained preferably in an amount of 10 to 500 parts by weight of 100 parts by weight of the solid epoxy resin.

The solvent is not strictly restricted provided that it can dissolve (ionize) the alkali metal compound or alkali earth metal compound.

The chemical grout of the invention comprising the above-mentioned components may further comprise a glass fiber, if necessary. The glass fiber is added to increase tensile strength and crack resistance of the chemical grout when it is hardened.

For the glass fiber, E-component long glass fiber or alkali resistance component fiber can be used and in particular, there can be used a chopped fiber which is made by chopping a glass fiber or carbon fiber having a fiber diameter of 10 to 20 [symbol] into uniform strand length or a milled fiber which is made by milling it into an average fiber length. Especially, it is preferred that the chopped fiber is cut to have a fiber length of 2 to 12 mm and the milled fiber has an average fiber length of 100 to 300 [symbol] . The milled fiber is advantageous in consideration of the reinforcement of the tensile strength and dispersion of the chemical grout, and there can be also used a mixture of the chopped fiber and the milled fiber.

The glass fiber is contained preferably in an amount of 1 to 100 parts by weight of 100 parts by weight of the solid epoxy resin. When the amount of the glass fiber is within the above ranges, the hardened construction material grout has excellent tensile strength and crack, shrinkage and expansion do not occur. Also, when the chemical grout of the invention is used while being divided into the main ingredient and the hardener, the glass fiber can be divided into appropriate amounts and contained in the main ingredient and the hardener and preferably, it is contained in an amount of 10 to 90 parts by weight in the main ingredient and the hardener, respectively.

The foaming chemical grout of the present invention comprising the above-illustrated components expands its volume more than 1.5 times as compared with the prior chemical grout when hardened after mix, it has excellent filling performance in upper sides against gravity, especially in crack and eroded cave regions having counter direction against gravity like ceilings and walls due to its excellent foaming ability when injected and foamed, and it has high-intensity, closed pore structures thereby resulting in excellent filling effects even in places subject to pressure or load.

Furthermore, the foaming chemical grout of the invention makes working in wet or aquatic environments easy because the chemical grout pushes water present in crack regions as it expands, thereby blocking crack or eroded cave and cavity regions without gap, it has excellent adhesion and working performances by single process without requiring additional processes, and it is easy and simple to operate so that it has excellent effects on the construction, repair and reinforcement of a structure.

Further, the present invention provides a method for the construction, repair and reinforcement of a structure which is characterized in that the foaming chemical grout is applied to a crack region, cavity, eroded caved region or shocrete construction.

The construction, repair and reinforcement method of structures can be suitably selected and applied in consideration of purpose, cause of crack, morphology and size of crack, importance of structures, structure format, environment conditions, or life time after repair and for example, there are filling or injection methods into crack or cavity or eroded caved aperture regions of structures.

The filling or injection methods in the crack or eroded caved aperture regions of the structures are carried out by filling or injecting the foaming chemical grout into the region of interest.

The injection methods include mechanical injection method, manual injection method, pedal injection method, hydraulic method, etc. and can be suitably selected and applied by an ordinary person in the pertinent art. For instance, in case of the reinforcement of tunnel ceiling regions having cracks or eroded caves, the construction, repair and reinforcement of the structures are carried out by installing an injection pack in upper side of the crack or eroded cave regions, mixing the main ingredient and the hardener of the foaming chemical grout of the invention, injecting it into the upper side by applying pressure, and finishing the surface of the cracks after the removal of the injection pack, and in case of penetration, the construction, repair, and reinforcement of the structures are carried out by installing a protective barrier on one side of the penetrated cracks, cavity or eroded cave and then performing the above procedures.

In the construction, repair and reinforcement methods of the structures based on the injection of the invention, the foaming chemical grout is penetrated into a main body and then foamed while being hardened, thereby intensifying the intensity of the main body, and it reaches the depth of cracks or eroded caves by penetrating bubbles and water in the closed cracks or eroded caves, thereby completely filling the crack gaps and restoring them. Also, as it supplements tensile strength which is the weakness of a main body when hardened, it prevents re-cracking, it is flexibly adjusted by temperature change and it shows no shrinkage during hardening process. In addition, the chemical grout injected by the above method can efficiently restore wide crack, cavity or eroded cave regions with a small amount due to its superior foaming ability and it has a specific gravity similar to the structures so that it does not have harmful effects on engineering works or constructs.

Further, of the repair and reinforcement methods of the structures, the method of filling or injection into the cracked cavity regions of the structures is preferably applied to crack regions, cavities, eroded cave regions, or shocrete construction having a counter direction against gravity, especially crack or eroded cave regions of wet or aquatic environments.

This method is carried out by filling the foaming chemical grout into a filling region using ordinary methods after cleaning the filling region without additional preparation.

In the filling method using the prior chemical grout, it flew out or was absorbed in a high specific gravity so that it did not completely fill crack gaps when injected into the crack or eroded cave regions having cracks in a counter direction against gravity such as ceiling regions of tunnels. However, the filling method using the foaming chemical grout of the invention can completely fill them with a small amount due to excellent foaming ability of the foaming chemical grout and restore them, it does not cause the falling-off of an adhesion side after hardening process, and it has excellent effects especially on constructions in aquatic and wet environments.

Also, in the shocrete construction, when tunnels are constructed, the foaming chemical grout is installed as a shocrete agent after blasting and rapidly hardened, thereby enabling subsequent tunnel lining work to be continuously constructed within short time so that it can prevent air contraction and material separation phenomena and intensify the bonding of lining agents and the interadhesion of earth rocks.

In addition, the construction method of the invention can be used to repair and reinforce the bottom of a ship, mechanical parts, etc. in aquatic environments by injecting, filling or coating the foaming chemical grout of the invention into the crack regions.

The foaming chemical grout in accordance with the invention satisfies acid resistance, alkali resistance, injection performance, inflow performance, impact resistance, crack resistance, adhesion, and storage ability at the same time, and it enables the function and shape of the structure to be completely restored within short time due to simple construction and fast hardening, it supplements the properties of the structure such as tensile strength and strongly adheres to the structure thereby extending the life-time of the structure, and it enables the perfect restoration of damaged external appearance.

For better understanding of the present invention, preferred embodiments follow.

The following examples are intended to illustrate the invention more fully without limiting the scope of the invention.

### EXAMPLE

### Example 1

A main ingredient was prepared by uniformly mixing 1 kg of epoxy liquid resins, 1 kg of glass powders having an average diameter of 200 mesh and a specific gravity of 2.54, 300 g of glass beads having an average diameter of 0.1 mm as a filling agent, 50 g of NaCl as an alkali metal compound or alkali earth metal compound, and 300 g of a solvent.

Next, a hardener was prepared by uniformly mixing 500 g of aluminum powders, 300 g of glass beads having an average diameter of 0.1 mm as a filling agent and 400 g of an epoxy hardening agent.

A foaming chemical grout was prepared by mixing the above-prepared main ingredient and hardener.

### Example 2

A foaming chemical grout was prepared by mixing the main ingredient and the hardener in accordance with the same method as Example 1, with the exception that 100 g of a milled glass fiber having an average fiber thickness of 13.5 [symbol] and an average fiber length of 300 [symbol] was added to the main ingredient of Example 1.

Example 3

A foaming chemical grout was prepared by mixing the main ingredient and the hardener in accordance with the same method as Example 1, with the exception that calcium carbonate (CaCO₃) was used instead of the glass beads of Example 1 as a filling agent.

Comparative Example 1

A chemical grout was prepared by mixing 1 kg of epoxy liquid resins with 100 g of benzyl alcohol, adding 3 kg of glass beads having an average diameter of 0.1 mm thereto and mixing them in a conventional mixer.

The grouts prepared in Example 1 and Comparative Example 1 were injected into a cracked ceiling. As a result, the chemical grout of Example 1 prepared in accordance with the present invention was hardened without running down outside the cracked parts and it was consumed only half the amount of the grout of Comparative Example 1. On the other hand, the grout of Comparative Example 1 was used more than twice the amount of Example 1 and it ran down from the crack parts. Accordingly, it can be seen that the foaming chemical grout in accordance with the invention does not run down even in crack regions having a counter direction against gravity and it enables excellent repair and reinforcement by the use of small amount.

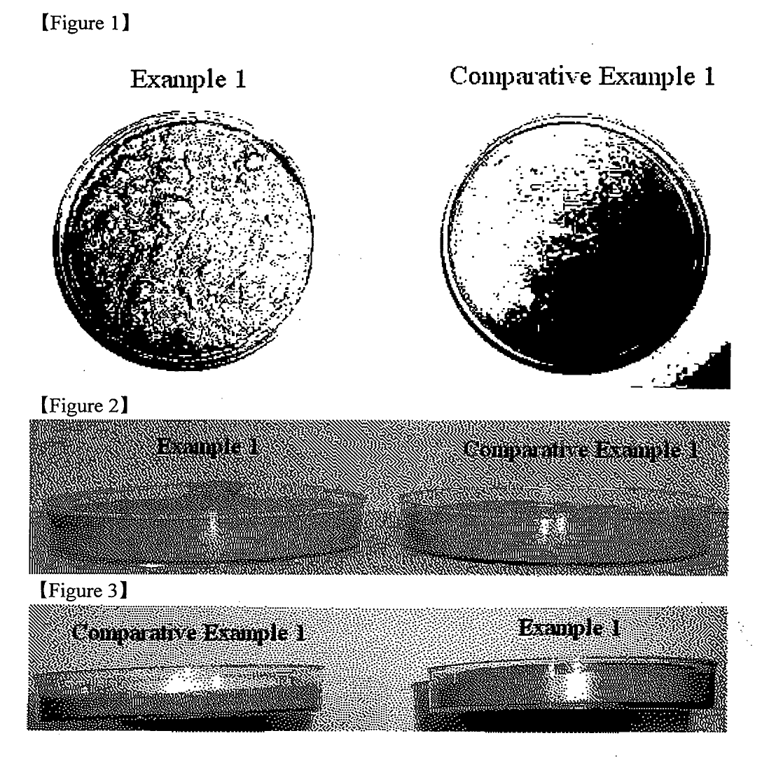

Also, the foaming ability of the chemical grouts prepared in Example 1 and Comparative Example 1 were measured. As shown in FIGS. 1 to 3, the chemical grout of Example 1 prepared in accordance with the invention had more than twice the foaming rate of Comparative Example 1.

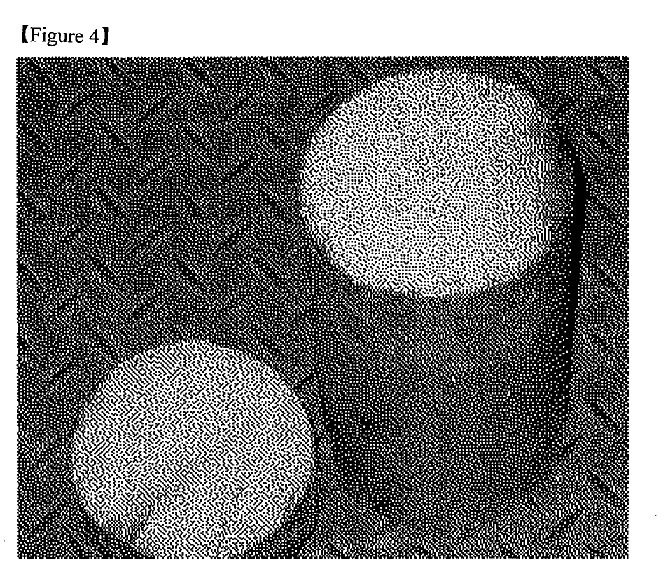

Also, FIG. 4, a sectional view of the chemical grout prepared in the invention which is injected into a cylinder-shaped barrel of which the inside is empty and foamed and then hardened, shows that the grout was filled into entire regions of the cylinder without crack. Accordingly, it can be seen that the chemical grout of the invention enables perfect repair and reinforcement without gap of apertures or cracks when injected into the crack regions and foamed.

### INDUSTRIAL APPLICABILITY

The foaming chemical grout in accordance with the present invention has excellent filling performance in upper sides against gravity, especially crack and eroded cave regions having counter direction against gravity like ceilings due to its excellent foaming ability when injected and foamed, has high-intensity, closed pore structures thereby resulting in excellent filling effects even in places subject to pressure or load, has excellent adhesion and working performances thereby enabling single process without requiring additional processes even in wet and aquatic environments, and is easy and simple to operate thereby having excellent effects on the construction, repair and reinforcement of a structure. Also, the foaming chemical grout of the invention satisfies acid resistance, alkali resistance, injection performance, inflow performance, impact resistance, crack resistance, adhesion, and storage ability at the same time, and further it has affinity with materials, it enables the function and shape of the structure to be completely restored within short time due to simple construction and fast hardening, it supplements the properties of the structure such as tensile strength and strongly adheres to the structure thereby extending the life-time of the structure, and it enables the perfect restoration of damaged external appearance.

1. A foaming chemical grout comprising:
a) 100 parts by weight of an epoxy resin (based on solids);
b) 10 to 500 parts by weight of a glass powder;
c) 10 to 500 parts by weight of a filling agent;
d) 1 to 500 parts by weight of an alkali metal compound or alkali earth metal compound;
e) 1 to 500 parts by weight of a metal powder;
f) 10 to 100 parts by weight of a hardening agent; and
g) 10 to 500 parts by weight of a solvent.

2. The foaming chemical grout of claim 1 characterized in that the foaming chemical grout comprises: a main ingredient containing
i) 100 parts by weight of an epoxy resin (based on solids);
ii) 10 to 500 parts by weight of a glass powder;
iii) 10 to 490 parts by weight of a filling agent;
iv) 1 to 500 parts by weight of an alkali metal compound or alkali earth metal compound; and
v) 10 to 500 parts by weight of a solvent; and a hardener containing
i) 1 to 500 parts by weight of a metal powder;
ii) 10 to 490 parts by weight of a filling agent; and
iii) 10 to 100 parts by weight of a hardening agent.

3. The foaming chemical grout of claim 1 wherein the epoxy resin of a) is selected from the group consisting of bisphenol A epoxy resin, bisphenol F epoxy resin, bisphenol S epoxy resin, alicyclic epoxy resin, aliphatic cyclic epoxy resin, phenol novolak epoxy resin, cresol novolak epoxy resin, bisphenol A novolak epoxy resin, diglycidyl ether of biphenol, diglycidyl ether of naphthalenediol, diglycidyl ether of phenol, diglycidyl ether of alcohol, alkyl substituents, halides or hydrogen additives thereof, and combination thereof.

4. The foaming chemical grout of claim 1 wherein the glass powder of b) has a diameter of 10 μm to 1 mm.

5. The foaming chemical grout of claim 1 wherein the filling agent of c) is selected from the group consisting of glass bead, calcium carbonate (CaCO₃), calcium sulfate, barium sulfate, white clay, dix clay, yellow clay, ash, silica (SiO₂), and combination thereof.

6. The foaming chemical grout of claim 5 wherein the filling agent is a glass bead having a diameter of 1 μm to 3 mm.

7. The foaming chemical grout of claim 1 wherein the alkali metal compound or alkali earth metal compound of d) is a compound containing at least one alkali metal or alkali earth metal selected from group consisting of Li, Na, K, Rb, Cs, Fr, Be, Mg, Ca, Sr, Ba, and Ra.

8. The foaming chemical grout of claim 1 further comprising a chopped fiber which is made by chopping a glass fiber or carbon fiber having a fiber diameter of 10 to 20 μm into uniform strand length or a milled fiber which is made by milling it into average fiber length of 100 to 300 μm in an amount of 1 to 100 parts by weight of 100 parts by weight of the solid epoxy resin.

9. The foaming chemical grout of claim 1 wherein the metal powder of e) is a compound containing at least one metal selected from the group consisting of Al, Zn, Fe, Ni, Sn, Pb, and Cu.

10. The foaming chemical grout of claim 1 wherein the hardening agent of f) is an epoxy hardening agent.

11. A grout hardened by mixing the foaming chemical grout of claim 1.

12. A method for the construction, repair, and reinforcement of a structure characterized in that the foaming chemical grout of claim 1 is applied to a crack region, eroded cave region, cavity or shocrete construction.

13. The method of claim 12 wherein the construction, repair, and reinforcement of the structure is carried out by filling or injecting the foaming chemical grout into a cracked or eroded caved cavity region in the structure of dry, wet or aquatic environment.

14. The method for the repair and reinforcement of the structure of claim 12 wherein the structure is a ceiling of a tunnel, crack region of a structure, eroded cave region of a structure or degradation region of a structure.
